(19) United States
(12) Patent Application Publication
(10) Pub. No.: US 2008/0103886 A1
(43) Pub. Date: May 1, 2008

(54) DETERMINING RELEVANCE OF A TERM TO CONTENT USING A COMBINED MODEL

(75) Inventors: Hua Li, Beijing (CN); Zheng Chen, Beijing (CN); Benyu Zhang, Beijing (CN); Hua-Jun Zeng, Beijing (CN); Jian Wang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/553,897

(22) Filed: Oct. 27, 2006

(51) Int. Cl. G06Q 30/00

(52) U.S. Cl. 705/14

(57) ABSTRACT

A method and system for generating and using a combined model to identify whether a bid term is relevant to an advertisement is provided. A relevance system trains a combined model that includes an initial model and a decision tree model that are trained using features that represent relationships between bid terms and advertisements. The relevance system trains the initial model to map initial model features to a modeled relevance. The relevance system trains the decision tree model to map the decision tree features and the modeled relevance to a final relevance. The trained initial model and decision tree model represent the combined model. The relevance system then uses the combined model to determine the relevance of bid terms to advertisements.

### BACKGROUND

Many web sites provide their services free to users, but may derive significant revenue from advertisements presented to the users. These advertisements are typically either a sponsored link that is inserted into a web page or advertisement content that is displayed as part of a web page. While advertisement content can be added to any web page by any type of web site, sponsored links are typically used by search services, such as a search engine service.

Search engine services obtain revenue by placing advertisements along with search results. These paid-for advertisements are commonly referred to as “sponsored links,” “sponsored matches,” or “paid-for search results.” An advertiser who wants to place an advertisement (e.g., a link to their web page) along with certain search results provides a search engine service with an advertisement and one or more bid terms. When a search request is received, the search engine service identifies the advertisements whose bid terms most closely match those of the search request. The search engine service then selects advertisements to display based on the closeness of their match along with the amount of money that the advertisers are willing to pay for placing the advertisement. The search engine service then adds a sponsored link to the search result that points to a web page of the advertiser. The search engine services typically either charge for placement of each advertisement along with search results (i.e., cost per impression) or charge only when a user actually selects a link associated with an advertisement (i.e., cost per click).

Many web sites, including search engine services, rely on an advertisement server for providing advertisements to display on web pages of the web site. When a web site serves a web page to a user, the web page may include advertisement links to the advertisement server at locations on the web page where advertisements are to be presented. When the user's computer receives the web page, it resolves each advertisement link by sending a request to the advertisement server. Upon receiving a request, the advertisement server selects an advertisement that is appropriate to the web page and responds to the request by providing the content of the advertisement to the user's computer. Upon receiving the content, the user's computer displays the advertisement at the appropriate location on the web page. Similar to search engine services, advertisement services typically either charge for placement of each advertisement on a web page (i.e., cost per impression) or charge only when a user actually selects an advertisement (i.e., cost per click). The advertisement server splits the fee it collects from the advertiser for placing the advertisement with the web site that served the web page. Thus, both the advertisement server and the web site benefit from placement of the advertisement.

Advertisement servers typically have a database of advertisements that map bid terms to advertisements and bid amounts. Advertisers who want to have their advertisements placed may submit triples of bid term, bid amount, and advertisement. When the advertisement server receives a request for an advertisement, it identifies bid terms that are relevant to the content of the web page on which the advertisement is to be placed. The advertisement server then selects the advertisement for a bid term that is relevant to the content of the web page, factoring in the bid amount. For example, an advertisement server may select an advertisement with a bid term that is not as relevant as other bid terms because the advertiser is willing to pay more for the placement of the advertisement.

Advertisers would like to maximize the effectiveness of their advertising dollars used to pay for advertisements. Thus, advertisers try to identify bid terms and advertisement combinations that result in the highest benefits (e.g., most profit) to the advertiser. As such, some advertisers select as bid terms popular words regardless of whether the popular terms are related to the advertisements. For example, an advertiser may select the popular terms of “Harry” and “Potter” as bid terms for an advertisement for an automobile even though Harry Potter is not relevant to an advertisement for an automobile. Because search requests relating to Harry Potter are very common and web pages relating to Harry Potter are very popular, the advertiser's advertisement will be eligible to be placed frequently because the bid terms match web pages that relate to Harry Potter. Although the use of popular words as bid terms may increase the profits of the advertiser, it may decrease the profits of advertisement servers, the search engine services, and web sites that place the advertisements. In particular, a user who is searching for information or accessing a web page relating to Harry Potter is likely uninterested in seeing an advertisement for an automobile. In such a case, the user is unlikely to select an advertisement for an automobile and thus the advertisement server, the search engine service, and the web site will not gain any revenue, especially when revenue is derived on a cost-per-click basis. Even if revenue is derived on a cost-per-impression basis, the users of search engine services and web sites that display advertisements that are not relevant may well become so annoyed that they stop using such services and sites, resulting in loss of revenue. To prevent the placement of advertisements on web pages that are not relevant to the content of the web page, advertisement servers attempt to identify bid terms that are not relevant to their advertisements. When an advertisement server identifies such a bid term, it can discard the advertisement.

### SUMMARY

A method and system for generating and using a combined model to identify whether a term is relevant to content is provided. A bid term relevance system trains a combined model that includes an initial model and a decision tree model. The relevance system trains the initial model and the decision tree model using training data that includes bid term and advertisement pairs and, for each pair, a modeled feature label and a relevance label. The relevance system trains the initial model using initial model features that represent relationships between the bid term of a pair and its advertisement. The initial model maps the initial model features to modeled features. The initial model may be based on a support vector machine model, an adaptive boosting model, a naive Bayes network model, and so on. The relevance system trains the decision tree model using decision tree model features that represent relationships between the bid term of a pair and its advertisement. The relevance system trains the decision tree model using the decision tree model features and the modeled features as features and the relevance labels to generate a mapping of such features for a pair to its relevance. The trained initial model and decision tree model represent the combined model.

After the combined model is trained, the relevance system can use the combined model to determine the relevance of a bid term to an advertisement. When the relevance system receives a bid term and advertisement pair, the relevance system extracts the initial model features and the decision tree model features from the pair. The relevance system then applies the initial model to the initial model features to determine the modeled feature associated with the initial model features. The relevance system then applies the decision tree model to features that include the decision tree model features and the modeled feature of the pair to determine the relevance of the bid term to the advertisement.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the relevance system in one embodiment.

FIG. 2 is a flow diagram that illustrates the processing of the train models component of the relevance system in one embodiment.

FIG. 3 is a flow diagram that illustrates the processing of the extract features component of the relevance system in one embodiment.

FIG. 4 is a flow diagram that illustrates the processing of the determine relevance component of the relevance system in one embodiment.

### DETAILED DESCRIPTION

A method and system for generating and using a combined model to identify whether a term is relevant to content is provided. In one embodiment, a bid term relevance system trains a combined model that includes an initial model and a decision tree model. The relevance system trains the initial model and the decision tree model using training data that includes bid term and advertisement pairs and, for each pair, a modeled feature label and a relevance label. In one embodiment, the modeled feature label for a pair may be the same as the relevance label for the pair. The relevance system trains the initial model using initial model features that represent relationships between the bid term of a pair and its advertisement. For example, one initial model feature may be an indication of whether the content of the advertisement contains the bid term. The relevance system trains the initial model using the initial model features and the modeled feature label for each pair to generate a mapping of initial model features of a pair to a modeled feature. The modeled feature labels may be scores generated manually by reviewers of the training data indicating relevance of the bid term of a pair to its advertisement. The initial model may be based on a support vector machine model, an adaptive boosting model, a naive Bayes network model, and so on.

The relevance system trains the decision tree model using decision tree model features that represent relationships between the bid term of a pair and its advertisement. For example, one decision tree model feature may be an indication of whether the content of the advertisement contains synonyms of the bid term. The relevance system trains the decision tree model using the decision tree model features and the modeled feature label as features and the relevance labels to generate a mapping of such features for a pair to its relevance. The relevance labels may be manually determined by reviewers and indicate the relevance (e.g., relevant or not relevant) of a term of a pair to its advertisement. The trained initial model and decision tree model represent the combined model.

After the combined model is trained, the relevance system can use the combined model to determine the relevance of a bid term to an advertisement. When the relevance system receives a bid term and advertisement pair, the relevance system extracts the initial model features and the decision tree model features from the pair. The relevance system then applies the initial model to the initial model features to determine the modeled feature associated with the initial model features. The relevance system then applies the decision tree model to features that include the decision tree model features and the modeled feature of the pair to determine the relevance of the bid term to the advertisement.

The use of a combined model allows different sets of features to be used as initial model features and as decision tree model features depending on the intended usage of the relevance system. In one embodiment, the relevance system may use a cross-validation technique to select the most effective sets of features. The relevance system may generate combined models using different sets of initial model features and decision tree model features using most of the training data. The rest of the training data can be used to assess the accuracy of the various combined models. The relevance system can then use the sets of features that result in the best accuracy. The relevance system can use the combined model that is already trained or can retrain the combined model using all the training data.

In one embodiment, the relevance system may use features that are based on content relevance and features that are based on concept relevance. The features relating to content relevance are calculated based on the similarities between bid terms and their expansions (e.g., synonyms) to advertisement title, advertisement metadata (e.g., description), advertisement content, advertisement URL, and so on. For example, a feature based on content relevance may indicate whether the advertisement title contains the bid term. The features relating to concept relevance are calculated as category similarities between bid terms and their expansions to advertisement title, advertisement metadata, advertisement content, advertisement URL, and so on. The relevance system may train models to generate scores for the features based on content relevance and concept relevance. A technique for training such models and extracting features based on content relevance and concept relevance is described in U.S. patent application Ser. No. 10/826,162, entitled “Verifying Relevance Between Keywords and Web Site Contents” and filed on Mar. 15, 2004, which is hereby incorporated by reference. That patent application also describes a single model for determining relevance of a keyword to the content of a website. Table 1 describes the features used by the relevance system in one embodiment.

TABLE 1

Bid term/Content (exact match * dynamic programming)
Bid term/Content (exact match)
Bid term/Title (exact match * dynamic programming)
Bid term/Title (exact match)
Bid term/Metadata (exact match * dynamic programming)
Bid term/Metadata (exact match)
Bid term/URL text (exact match)
Bid term/Redirected URL text (exact match)
Bid term expansion/Content (exact match)
Bid term expansion/Title (exact match)
Bid term expansion/Metadata (exact match)
Bid term expansion/URL text (exact match)
Bid term expansion/concept scores (9 features)

An “exact match” feature for text is the inner product of a normalized term frequency vector for a bid term and for the text (e.g., content, title, or metadata). An “exact match *dynamic programming” feature is the “exact match” feature weighted by a dynamic programming score. The dynamic programming score is a distance metric between the terms of the text that are considered to match the bid term. The “exact match” feature for a URL is the percentage of words of the URL that match the bid term. The URL words are non-stop words delimited by separations (e.g., ”.” and “\”). The concept features are calculated by first classifying the bid term expansion and landing page each into three categories each, using, for example, a support vector machine. The outer product of these two three-element vectors is then calculated to give a 3×3 matrix. Each element of the matrix is a concept feature.

The relevance system may use a support vector machine as the initial model. A support vector machine operates by finding a hyper-surface in the space of possible inputs. The hyper-surface attempts to split the positive examples (e.g., features of relevant bid terms) from the negative examples (e.g., features of not relevant bid terms) by maximizing the distance between the nearest of the positive and negative examples to the hyper-surface. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See Sequential Minimal Optimization, at http://research.microsoft.com/˜iplatt/smo.html.)

The relevance system may alternatively use an adaptive boosting technique for the initial model. Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier. Adaptive boosting may use weak classifiers that are single-split trees with only two leaf nodes.

The relevance system may alternatively use a naive Bayes network model as the initial model. A naïve Bayes network model is described in U.S. patent application Ser. No. 10/826,162, entitled “Verifying Relevance Between Keywords and Web Site Contents” and filed on Mar. 15, 2004.

The relevance system uses a decision tree model to make the final relevance determination. A decision tree model is typically represented by rules that divide data into a series of binary hierarchical groupings or nodes. Each node has an associated rule that divides the data into two child groups or child nodes. A decision tree is constructed by recursively partitioning training data. At each node in the decision tree, the relevance system selects a partition that tends to maximize some metric. The relevance system recursively selects sub-partitions for each partition until the metric indicates that no more partitions are needed. A metric that is commonly used is based on information gain. Decision tree models and appropriate metrics are described in Quinlan, J. R., “Programs for Machine Learning,” Morgan Kaufman Publishers, 1993, which is hereby incorporated by reference. A decision tree model is used to classify data by applying the rules of the tree to the data until a leaf node is reached. The data is then assigned the classification (e.g., relevant or not relevant) of the leaf node.

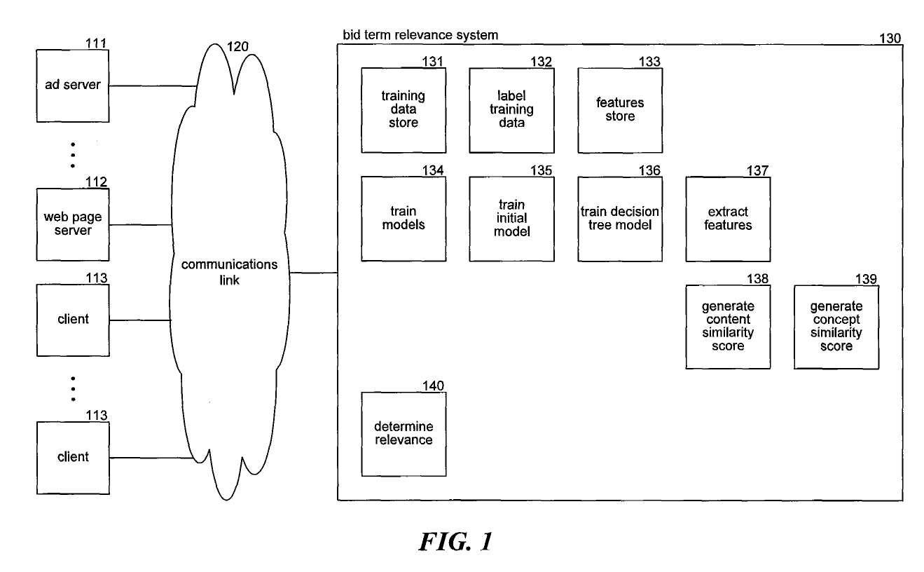

FIG. 1 is a block diagram that illustrates components of the relevance system in one embodiment. The bid term relevance system 130 is connected to various advertisement servers 111, web page servers 112, and client devices 113 via communications link 120. The advertisement servers and web page servers may provide training data for the relevance system and may use the relevance system to determine whether bid terms are relevant to advertisements. The client devices may interact with web page servers or search engine services. The relevance system includes a training data store 131, a label training data component 132, and a feature store 133. The training data store contains the training data that includes bid term and advertisement pairs. Each advertisement may include advertisement title, advertisement description, advertisement content, and a URL and/or redirected URL or corresponding data when the advertisement is a sponsored link. The label training data component provides the bid term and advertisement pairs to a reviewer who provides the modeled feature label and the relevance label for the pair. The label training data component then stores the labels in the training data store. The feature store identifies the set of the initial model features and the set of decision tree model features for training and using the combined model. The initial model features and the decision tree model features may have no features in common or may have one or more features in common. The relevance system also includes a train models component 134, a train initial model component 135, a train decision tree model component 136, an extract features component 137, a generate content similarity score component 138, and a generate concept similarity score component 139. The train models component invokes the extract features component to extract features of the training data. The train models component then invokes the train initial model component to train the initial model and the train decision tree model component to train the decision tree model using the extracted features and the labels. The extract features component may invoke the generate content similarity score component and the generate concept similarity score component to extract features that relate to content and concept similarity. The relevance system also includes a determine relevance component 140 that is provided with a bid term and advertisement pair and uses the combined model of the initial model and the decision tree model to determine whether the bid term is relevant or not relevant to the advertisement.

The computing device on which the relevance system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the relevance system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the relevance system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The relevance system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

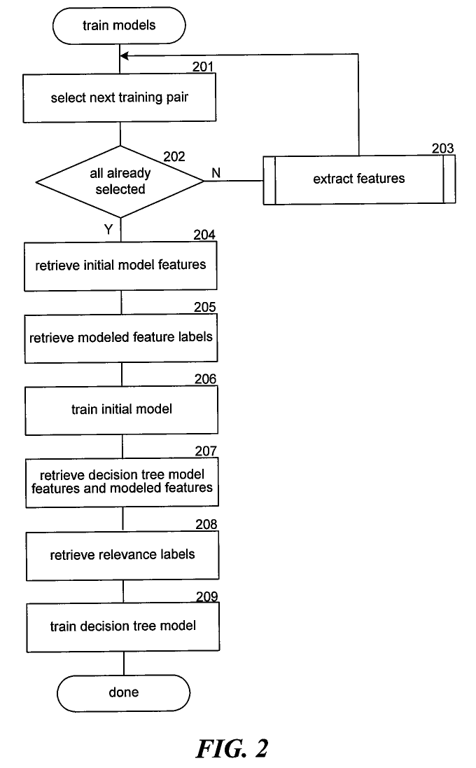

FIG. 2 is a flow diagram that illustrates the processing of the train models component of the relevance system in one embodiment. The component is invoked to train the models using the training data of the training data store. In blocks 201-203, the component loops extracting features for each bid term and advertisement pair of the training data. In block 201, the component selects the next pair of training data. In decision block 202, if all the pairs of training data have already been selected, then the component continues at block 204, else the component continues at block 203. In block 203, the component invokes the extract features component to extract features for the selected pair. The component then loops to block 201 to select the next pair. In block 204, the component retrieves the initial model features for the training data. In block 205, the component retrieves the modeled feature labels for the training data. In block 206, the component trains the initial model using an adaptive boosting technique to generate the model features from the initial model features. In block 207, the component retrieves the decision tree model features for the training data and the corresponding model features. In block 208, the component retrieves the relevance labels for the training data. In block 209, the component trains a decision tree model using the decision tree model features and the modeled feature of each pair of training data and relevance labels. The decision tree model is trained to map the decision tree model features and the modeled feature of a pair to the appropriate relevance. The component then completes.

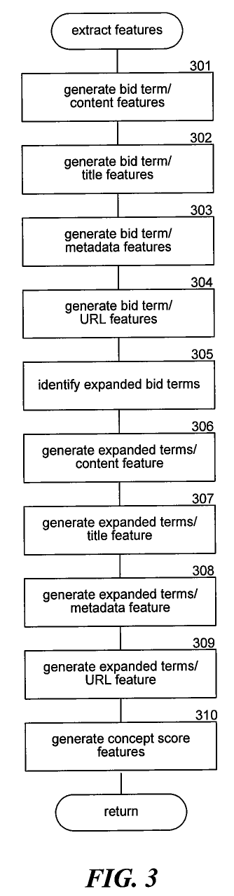

FIG. 3 is a flow diagram that illustrates the processing of the extract features component of the relevance system in one embodiment. The component is passed a bid term and an advertisement and extracts the content features and concept features. In block 301, the component generates bid term and content features that indicate the similarity between the bid term and the content. In block 302, the component generates bid term and title features that indicate the similarity between the bid term and the title. In block 303, the component generates bid term and metadata features that indicate the similarity between the bid term and the metadata of the advertisement. In block 304, the component generates a bid term and URL feature that indicates the similarity between a bid term and the URL and/or a redirected URL. In block 305, the component identifies expanded bid terms. In block 306, the component generates a feature that indicates similarity between the expanded terms and the content. In block 307, the component generates a feature that indicates similarity between the expanded terms and the title. In block 308, the component generates a feature that indicates similarity between the expanded terms and the metadata. In block 309, the component generates a feature that indicates a similarity between the expanded terms and the URL. In block 310, the component generates various concept-based features and then returns. The component may invoke the generate content similarity score component and the generate concept similarity score component to generate the features.

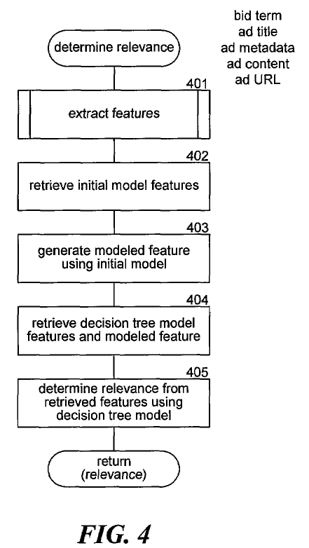

FIG. 4 is a flow diagram that illustrates the processing of the determine relevance component of the relevance system in one embodiment. The component is passed a bid term and advertisement data for an advertisement that includes a title, metadata or description, content, and a URL. The component determines whether the bid term is relevant to the advertisement. In block 401, the component invokes the extract features component to extract features showing the relationship between the bid term and the advertisement. In block 402, the component retrieves the initial model features. In block 403, the component generates a modeled feature by applying the initial model to the retrieved initial model features. In block 404, the component retrieves the decision tree model features and the modeled feature. In block 405, the component determines the relevance by applying the retrieved features to the decision tree model. The component then returns the relevance.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the principles of the relevance system can be applied to determining the relevance of a term to some content that is unrelated to an advertisement. Accordingly, the invention is not limited except as by the appended claims.

I/We claim:

1. A computer-readable medium encoded with computer-executable instructions to control a computing device to determine whether a term is relevant to content, by a method comprising:
extracting features representing relationships between the term and the content;
retrieving initial features of the extracted features;
applying an initial model to the initial features to generate a modeled feature representing the initial features, the initial model being trained using training data that includes term and content pairs by extracting initial features for each pair and includes a label for each pair indicating the modeled feature for the pair;
retrieving decision tree features of the extracted features; and
applying a decision tree model to the decision tree features and the modeled feature to generate relevance of the term to the content, the decision tree model being trained using training data that includes term and content pairs by extracting decision tree features for each pair and a modeled feature for each pair using the initial model and includes a relevance label for each pair indicating relevance of the term to the content of the pair.

2. The computer-readable medium of claim 1 wherein the initial model is based on an adaptive boosting technique.

3. The computer-readable medium of claim 1 wherein the initial model is based on a support vector machine.

4. The computer-readable medium of claim 1 wherein different sets of extracted features can be used as initial features and decision tree features.

5. The computer-readable medium of claim 1 wherein the term is a bid term for an advertisement and the content is content of the advertisement.

6. The computer-readable medium of claim 5 wherein the advertisement is a sponsored link.

7. The computer-readable medium of claim 5 wherein the advertisement includes a title and metadata and some features are based on relationship of the bid term to the title and the metadata.

8. The computer-readable medium of claim 1 wherein some of the extracted features are based on relationships between expanded terms and the content.

9. The computer-readable medium of claim 1 wherein the initial model is based on an adaptive boosting technique, wherein different sets of extracted features can be used as initial features and decision tree features, wherein the term is a bid term for an advertisement and the content is content of the advertisement, and wherein the extracted features are based on content relevance and concept relevance.

10. A computer-readable medium encoded with computer-executable instructions for controlling a computing device to train a combined model to determine whether a term is relevant to content, by a method comprising:
providing training data that includes term and content pairs, each pair having an associated relevance label indicating relevance of the term to the content;
for each pair, extracting features representing relationships between the term and the content of the pair, each feature being designated as an initial model feature or a decision tree model feature;
training an initial model using the initial model features and the relevance label of each pair to generate a modeled relevance from the initial model features; and
training a decision tree model using the decision tree features and the modeled relevance as features and the relevance label to generate the relevance labels from the decision tree feature and the modeled relevance,
wherein the initial model and the decision tree model form the combined model.

11. The computer-readable medium of claim 10 wherein the initial model is based on an adaptive boosting technique.

12. The computer-readable medium of claim 10 wherein the initial model is based on a support vector machine.

13. The computer-readable medium of claim 10 wherein different sets of features can be designated as the initial features and the decision tree features depending on the application of combined model.

14. The computer-readable medium of claim 10 wherein some features are based on content relevance and other features are based on concept relevance.

15. The computer-readable medium of claim 10 wherein the term is a bid term for an advertisement and the content is content of the advertisement.

16. The computer-readable medium of claim 10 wherein the term is a bid term for a sponsored link and the content is content associated with the sponsored link.

17. A computing device for determining whether a bid term is relevant to an advertisement, comprising:
a component that extracts initial features representing relationships between the bid term and the advertisement;
a component that applies an initial model to the initial features to generate a modeled relevance for the initial features;
a component that extracts decision tree features representing relationships between the bid term and the advertisement; and
a component that applies a decision tree model to the decision tree features and the modeled relevance to generate relevance of the bid term to the advertisement,
wherein different sets of features can be designated as the initial features and the decision tree features.

18. The computing device of claim 17 wherein the initial model is not a decision tree model.

19. The computing device of claim 17 wherein the features include features based on relationships between expansions of the bid term and the advertisement.

20. The computing device of claim 17 wherein the features include content features and concept features.
